(19) United States
(12) Patent Application Publication
(10) Pub. No.: US 2009/0082003 A1
(43) Pub. Date: Mar. 26, 2009

(54) Mobile Phone Code Editing Method and Apparatus

(76) Inventor: Per Thorell, Lund (SE)

Correspondence Address: COATS & BENNETT, PLLC, 1400 Crescent Green, Suite 300, Cary, NC, 27518, US

(21) Appl. No.: 11/858,522

(22) Filed: Sep. 20, 2007

(51) Int. Cl. H04M 3/00

(52) U.S. Cl. 455/419

(57) ABSTRACT

Existing mobile phone code is edited or new code generated using a remote web browser interface. According to one embodiment, the mobile phone comprises a web server and a code editor. The web server is configured to process an HTTP request generated by a remote HTTP client, the HTTP request including one or more code editing instructions. The code editor is configured to edit code stored at the mobile phone or create new code based on the one or more code editing instructions using a program identified by the HTTP request. According to an embodiment of the remote HTTP client, the client comprises a web browser. The web browser is configured to generate the HTTP request for delivery to the mobile phone web server over a transport layer IP connection established with the web server. The HTTP request identifies the program stored at the mobile phone.

### BACKGROUND

The present invention generally relates to mobile phone software, and particularly relates to remotely editing software stored on a mobile phone.

Mobile phone software is conventionally updated in three stages. A computer such as a personal computer (PC) or server maintained by a software developer or the phone manufacturer generates a software update package during the first stage. The software update package contains code modifications to be loaded onto target mobile phones. The computer includes programs for modifying mobile phone software by editing the underlying source code. For example, the computer may include a text editor for modifying C/C++ source code and a compiler for processing the modified C/C++ source code. The text editor may also be used to modify script-based source code. As used herein, the terms “code” and “source code” are interchangeable unless otherwise expressly noted and should be broadly interpreted to mean any sequence of statements and/or declarations written in any human-readable computer programming language such as C/C++, Java, BASIC, PERL, Python, Ruby, Smalltalk, Lisp, Boo, etc. The modified code is then packaged for subsequent delivery and installation by the target mobile phones.

During the second stage, the software update package is provided to the target mobile phones. The package may be directly delivered to a target phone over the air interface or indirectly over the Internet to a computer coupled to the mobile phone. Either way, the software update package self-installs during the third stage. The third stage may further involve validating that the correct software update package has been received and that the update has successfully completed.

Generation of software update packages for mobile phones is usually performed by the developer of the software being updated or the phone manufacturer. Mobile phone users cannot readily update their phone's software according to such an approach because they do not have access to the underlying code from which the phone software is generated. Accordingly, mobile phone users are completely removed from the software modification process, and instead, must rely on other entities for updates. Some conventional mobile phones include script editors which enable editing of code written in high-level scripting languages such as, Python, Ruby, PERL, JavaScript, Rexx, Boo, etc. However, conventional mobile phone script editors are not remotely accessible, e.g., through the Internet. To the contrary, the user locally accesses the script editor application, e.g., using the phone keypad. Locally editing script-based source code stored on a mobile phone is cumbersome, inefficient and error prone. Alternatively, a script file stored in a mobile phone may be transferred to a computer for editing and then transferred back to the phone when code editing is complete. Websites such as www.runbasic.com offer web-based software generation. However, code generation and modification occurs at an un-trusted website, not at the user's mobile phone. The open nature of web-based software generation may compromise software integrity. Further, web-generated software must be downloaded to a mobile phone before it can be used.

### SUMMARY

According to the methods and apparatus taught herein, code stored at a mobile phone is edited or new code created using a remote web browser interface. The mobile phone includes a web server and a code editor. The mobile phone web server conforms to the hypertext transfer protocol (HTTP) in that the server receives HTTP requests and provides HTTP responses in turn. An HTTP request is generated by a remote web browser and is addressed to the mobile phone web server. The HTTP request may include code input by a user of the web browser, e.g., by accessing a web page provided by the mobile phone web server. The code input may be directed to preexisting code stored at the mobile phone or new code. Either way, the code input is packaged into an HTTP request as one or more code editing instructions and sent to the mobile phone. The HTTP request also identifies a code editor maintained at the mobile phone for handling the code editing instructions included in the HTTP request. The mobile phone code editor may modify code text files or code stored in the mobile phone based on instructions extracted from the HTTP request. The HTTP request further includes a domain name or IP address identifying the web server.

The HTTP request is routed over the Internet or other packet-switched network to a packet-switched radio access network serving the mobile phone. The HTTP request is routed using the address included therein. The radio access network forwards the HTTP request to the mobile phone. The mobile phone web server recognizes that content of the HTTP request should be handled by the mobile phone code editor. In one embodiment, the mobile phone web server extracts the code editing instruction from the HTTP request and notifies the code editor. In another embodiment, the code editor directly extracts the code editing instructions from the HTTP request.

Either way, the extracted code editing instructions represent code modifications to be made at the mobile phone or new code to be created at the mobile phone. The instructions may correspond to particular code editing tasks such as deleting certain rows in a particular file, adding a character to a certain line of the file, etc. Alternatively, the instructions may represent actual code modifications. Regardless, the code editor modifies code stored in the mobile phone memory or file system or creates new code based on the extracted instructions. This way, the mobile phone user or other authorized entity such as the phone manufacturer or a software developer may remotely edit code stored at the mobile phone or create new code by generating an HTTP request addressed to the web server.

According to one embodiment, the mobile phone comprises a web server and a code editor. The web server is configured to process an HTTP request generated by a remote HTTP client, the HTTP request including one or more code editing instructions. The code editor is configured to edit code stored at the mobile phone or create new code based on the one or more code editing instructions included in the HTTP request using a program identified by the HTTP request. According to an embodiment of a remote computer, the computer comprises a web browser. The web browser is configured to generate the HTTP request for delivery to the web server included in the mobile phone over a transport layer IP connection established with the web server. The HTTP request includes the one or more code editing instructions and identifies the corresponding mobile phone code editing program.

Of course, the present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a block diagram of an embodiment of a mobile phone configured to edit preexisting code or create new code based on one or more instructions received from a remote web browser.

FIG. 2 illustrates an embodiment of a web page accessed by a remote web browser for inputting code editing instructions to a mobile phone.

FIG. 3 illustrates an embodiment of processing logic for providing code editing instructions to a mobile phone via a remote web browser.

FIG. 4 illustrates an embodiment of processing logic for editing code stored at a mobile phone or creating new code based on instructions received from a remote web browser.

FIG. 5 is a block diagram of an embodiment of the mobile phone of FIG. 1.

### DETAILED DESCRIPTION

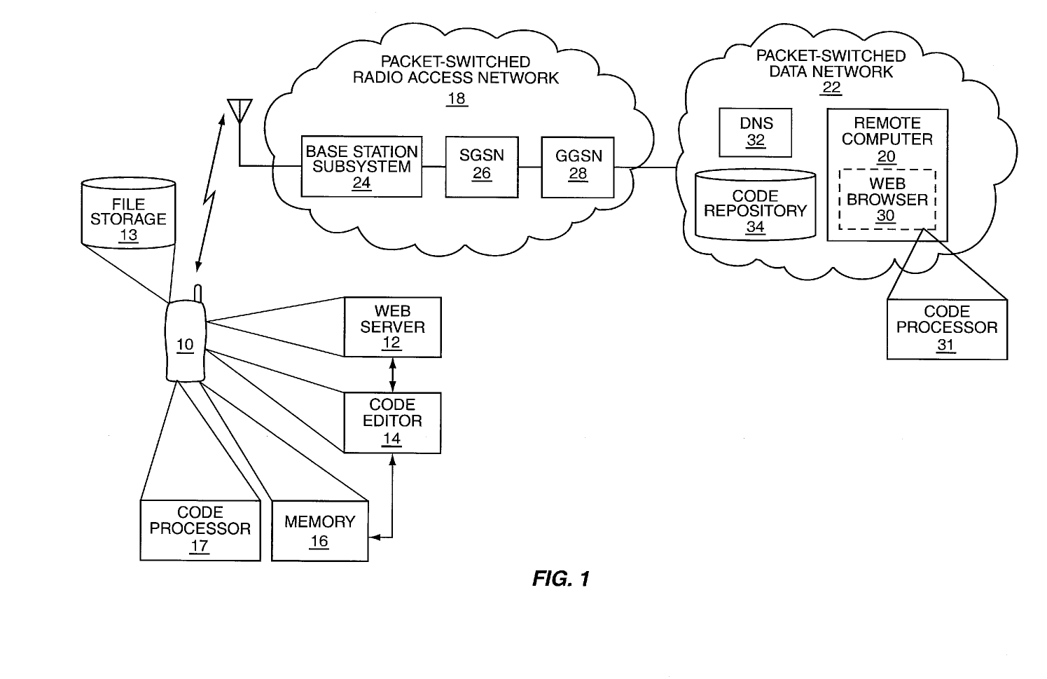

FIG. 1 illustrates an embodiment of a mobile phone 10 including a web server 12 and a code editor 14. The web server 12 supports the Hypertext Transfer Protocol (HTTP) for enabling remote editing of preexisting code stored in memory 16 included in the mobile phone 10 or creation of new code at the mobile phone 10. The web server 12 processes HTTP requests received from a packet-switched Radio Access Network (RAN) 18 serving the mobile phone 10. The HTTP requests are generated by a remote client computer 20 such as a PC or server having access to a packet-switched data network (PSDN) 22 such as the Internet. The remote computer 20 inserts code editing instructions in the HTTP requests. The code editing instructions represent code modifications to be made at the mobile phone 10 or new code to be created at the mobile phone 10.

In one embodiment, the code editor 14 performs one or more code editing tasks such as deleting certain rows in a particular file, adding a character to a certain line of the file, etc. in response to code editing instructions extracted from an HTTP request. This way, no code is actually included in the HTTP requests. Instead, the code editing instructions represent the code editing tasks to be performed by the code editor 14 for producing desired code modifications. Alternatively, the code editing instructions represent actual code. According to this embodiment, the code editor 14 stores the code included in the HTTP requests on file storage 13 or in the memory 16. The code editor 14 may then further process the code, e.g., by parsing or compiling the code.

Either way, the HTTP requests are routed from the remote computer 20 to the mobile phone web server 12 over the PSDN 22 and packet-switched RAN 18. This way, the mobile phone user or other authorized entity such as the phone manufacturer or a trusted software developer may remotely edit code stored at the mobile phone 10 or create new code by including the appropriate code editing instructions in an HTTP request addressed to the web server 12.

The mobile phone file storage 13 stores source code associated with applications running locally on the mobile phone 10. When an application is executed by the mobile phone 10, the corresponding code is loaded into mobile phone memory 16 and executed by a code processor 17 included in the phone 10. Program code stored in the file storage 13 may be modified based on instructions executed by the code editor 14. The code editor 14 may be integrated in the web server 12 or implemented as a separate entity, device or software program coupled to the web server 12. In one embodiment, the code editor 14 is a code editing program supported by the mobile phone 10 (such as a script editor or a compiler). In another embodiment, the code editor 14 is an interface to a code editing program. Regardless, the code editor 14 enables the phone 10 to create new code or edit existing code based on input received from a remote web browser 30. The interface that couples the code editor 14 to the web server 12, may for example correspond to an interface such as a Java servlet, CGI, Active Server Pages, Ruby on Rails or other similar interface.

The mobile phone web server 12 recognizes HTTP requests addressed to the server 12 which include code editing instructions directed to the mobile phone code editor 14. To this end, the web server 12 supports one or more interfaces for processing dynamic HTTP requests such as HTTP requests including code editing instructions. Each interface supported by the web server 12 enables the server 12 to extract instructions included in an HTTP request and pass the extracted instructions to the code editor 14. Alternatively, the code editor 14 directly extracts the code editing instructions from the HTTP request. In either embodiment, the code editor 14 then edits preexisting code or creates new code based on the extracted instructions.

The extracted instructions may identify the code to be edited. Alternatively, the code may be identified by the HTTP request. Further, the extracted instructions may correspond to actual code or to particular code editing tasks to be performed by the code editor 14. Regardless, the web server 12 optionally returns the code editing results to the remote computer 20 in the form of an HTTP response. The web server 12 may support any interface that enables the server 12 to interface with the code editor 14 at the mobile device 10. Such interfaces may include CGI, Simple CCGI (SCGI), FastCGI, Network layer Service Access Point Identifier (NSAPI), Internet Server Application Programming Interface (ISAPI), etc or interfaces to server side scripting frameworks such as Active Server Pages (ASP), PHP, Ruby on Rails, JavaServer Pages (JSP) etc.

The capability of the mobile phone web server 12 is limited only by the resources available to the mobile phone 10, e.g., memory bandwidth, communication bandwidth, processing power, etc. Minimally, the web server 12 functions as an HTTP server. However, the web server 12 may also function as an email server, Telnet server and/or File Transfer Protocol (FTP) server as mobile phone resources permit. The web server 12 is assigned an IP address for uniquely identifying the server 12. HTTP requests generated by the remote computer 20 are routed to the web server 12 based on the IP address included in the HTTP request. The packet-switched RAN 18 may comprise any type of packet-switched RAN such as a W-CDMA (Wideband Code Division Multiple Access) RAN, General Packet Radio Service/Enhanced Data rates for GSM Evolution (GPRS/EDGE), Wireless LAN, Bluetooth, WiMAX etc.

For ease of explanation only, operation of the packet-switched RAN 18 is described next with reference to a GPRS/EDGE RAN. FIG. 1 illustrates three nodes 24, 26, 28 included in the RAN 18 for supporting packet-switched communication, and particularly for supporting HTTP message routing between the mobile phone web server 12 and remote computer 20. The first node 24 is a Base Station Subsystem (BSS) for handling traffic and signaling between the mobile phone 10 and RAN 18. The BSS 24 transcodes speech channels, allocates radio channels, performs paging, manages quality of transmission and reception over the air interface and many other tasks related to the RAN 18 as is well known in the art. The second node 26 is a Serving GPRS support node (SGSN) for controlling connections between the RAN 18 and the mobile phone 10. The SGSN 26 performs session management and GPRS mobility management such as handovers and paging. The third node 28 is a Gateway GPRS Support Node (GGSN) for providing a gateway between the RAN 18 and the PSDN 22 and/or other GPRS networks (not shown). The GGSN 28 also assigns IP addresses to mobile phones served by the RAN 18 as is well known in the art. Accordingly, the GGSN 28 identifies HTTP requests addressed to the mobile phone web server 12 based on the IP address included in the request. The GGSN 28 forwards such HTTP requests to the SGSN 26 for delivery to the mobile phone web server 12 via the BSS 24.

HTTP requests addressed to the mobile phone web server 12 originate from the remote computer 20 which is connected to the PSDN 22. The remote computer 20 provides instructions to the mobile phone 10 by first establishing a transport layer connection with the web server 12 such as a Transmission Control Protocol-Internet Protocol (TCP-IP) or User Datagram Protocol (UDP) connection. A transport layer connection may be established by identifying the address of the web server 12 and a particular port of the server 12. This information may be entered using a web browser 30 included in the remote computer 20. The default port for TCP-IP connections is port number 80. However, a different port may be used to increase security. Security may be further increased by establishing an HTTP connection over an encrypted Secure Sockets Layer (SSL) or Transport Layer Security (TLS) transport mechanism. An SSL or TLS based HTTP connection uses a different default port (port number 443) and an additional encryption/authentication layer between HTTP and TCP. Regardless, the mobile phone web server 12 monitors the port identified in the connection request.

The mobile phone web server 12 may require user authentication before processing HTTP requests, e.g., by requesting a user ID and password. This way, only authorized entities gain access to the mobile phone code editor 14. After a transport layer connection is established, the web server 12 responds to the HTTP request, e.g., by sending an HTTP response to the computer's IP address provided as part of establishing the transport layer connection. The HTTP response includes a web page such as an HyperText Markup Language (HTML) or Extensible Markup Language (XML) document requested by the web browser 30. In one embodiment, the web page includes a copy of code stored in the mobile phone memory 16 or formatted source code retrieved from the file storage 13. The code may be stored in a directory accessible for code editing, e.g., a public file folder. Alternatively, the web page may provide a blank template for inputting new code. Broadly, the web page provides a mechanism for a user of the web browser 30 to input code editing instructions targeted to the mobile phone code editor 14.

Code editing instructions input by a user of the web browser 30 are included in an HTTP request which is sent from the remote computer 20 to the mobile phone web server 12. The HTTP request also identifies the mobile phone code editor 14 and the source code on the mobile phone 10 to be modified. The mobile phone code editor 14 has access to all information in the HTTP request and updates the source file based on the instructions previously entered by the user via the web browser 30. This way, code changes or new code may be input using the remote web browser 30 and provided to the mobile phone 10 for subsequent processing. Accordingly, neither the remote computer 20 nor the web browser 30 edits mobile phone code. The web browser 30 and computer 20 simply provide code editing instructions to the mobile phone 10 via HTTP requests.

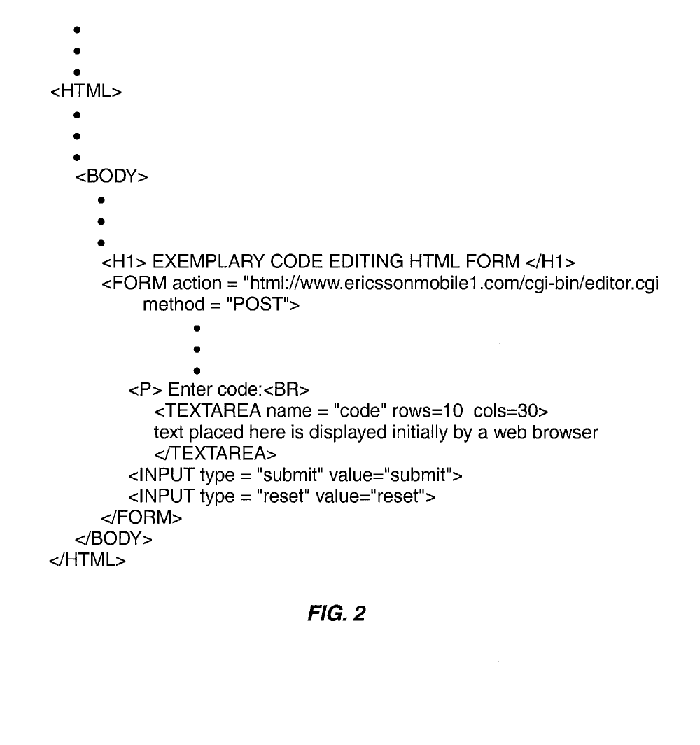

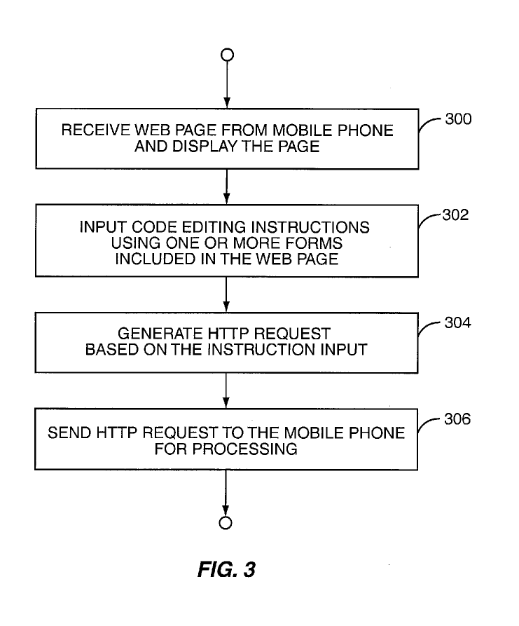

FIG. 2 illustrates one embodiment of an HTML-based web page provided by the mobile phone web server 12 to the remote web browser 30 for inputting code editing instructions. The web page may be generated by the code editor 14, web server 12 or other application. Regardless, the web page is provided to the web browser 30 as part of an HTTP response generated by the web server 12. The web server 12 generates the HTTP response based on an HTTP request received from the web browser 30. The HTTP request may solicit a web page for inputting new code. Alternatively, the HTTP request may solicit a web page containing a copy of code stored at the mobile phone 10 to be edited by a user of the web browser 30. Either way, the web browser 30 receives the web page and displays it in a visually favorable manner, e.g., as illustrated by Step 300 of FIG. 3.

The web page includes an HTML document delimiter (<HTML>), a body section delimiter (<BODY>), a header (<H1>), and a form element (<FORM>). According to this embodiment, code editing instructions are input using the form element, e.g., as illustrated by Step 302 of FIG. 3. The form element includes an action attribute specifying a Uniform Resource Locator (URL) or Uniform Resource Identifier (URI). The URL/URI identifies the mobile phone code editor 14 to which the form input is directed. In FIG. 2, the action attribute specifies an exemplary URL/URI of http://www.ericssonmobile1.com/cgi-bin that identifies an exemplary script-based code editing program named ‘editor.cgi’ stored in a ‘cgi-bin’ directory at the mobile phone 10.

The form element also includes a method attribute that specifies how instruction information input to the form is transmitted to the mobile phone web server 12. In FIG. 2, the method attribute specifies an HTTP POST request which has no limits on the amount of data that can be included in the request. The POST request also causes the instruction input to be sent on a separate line from the URL/URI. Alternatively, the method attribute may specify an HTTP GET request. The GET request appends instruction input to the end of the URL/URI designated by the action attribute. Preferably, the POST request is used when a large amount of instruction input is expected, e.g., when several lines of code input are expected.

The form element further includes one or more labels for directing a user of the web browser 30 where to enter input such as new code or edit preexisting code presented by the web page. In FIG. 2, an exemplary label “Enter Code:” is provided. This label alone may be sufficient for inputting new code. However, the form may be more complex when editing preexisting code. For example, labels identifying editable variables associated with the preexisting code may be provided for ease of use.

Text input fields included in the form element are the mechanism by which code editing instructions are input to the form. In FIG. 2, a single TEXTAREA field is provided. The TEXTAREA field provides a multiple-line text input area. The number of visible lines of text displayed by the web browser 30 is specified by the ‘rows’ attribute and the visible width of the text area is specified by the ‘cols’ attribute. Text initially displayed by the web browser 30 is placed between the start tag (<TEXTAREA>) and end tag (</TEXTAREA>) of the TEXTAREA field. The initial text may be overwritten by the browser 30. This is particularly useful for presenting preexisting code stored at the mobile phone 10. This way, a user of the web browser 30 is presented with a current version of the preexisting code and can make changes by simply entering the desired edits. A single-line text input field TEXT (not shown) may also be used for inputting single lines of text, e.g., new or edited variable values, author name, code name, etc. HTML and XML provide various types of fields for inputting information using the form element, e.g., push buttons, JavaScript buttons, radio buttons, check boxes, password fields, etc. This way, any desired type of code input or modifications may be accommodated.

Submit and reset buttons are also included in the form element. The reset button (<INPUT type=“reset” value=“reset”>) resets the values of all items in the form element to their original values when clicked or otherwise activated. The submit button (<INPUT type=“submit” value=“submit”>) causes the input entered in the form to be submitted. When the submit button is clicked or otherwise activated, an HTTP request is generated including the input entered in the form, e.g., as illustrated by Step 304 of FIG. 3. The HTTP request is addressed to the URL/URI specified by the ACTION attribute of the form element. The remote computer 20 then sends the HTTP request to the mobile phone web server 12 for processing, e.g., as illustrated by Step 306 of FIG. 3. In the present example, the code input to the form is edited by the ‘editor.cgi’ script identified by the URL/URI when the mobile phone 10 receives the HTTP request.

The specified URL/URI may include the domain name of the mobile phone web server 12 as shown in FIG. 2 (www.ericssonmobile1.com) or the corresponding IP address. Accordingly, the HTTP request is eventually routed to a Domain Name Server (DNS) 32 associated with the PSDN 22. The DNS 32 translates the domain name identified in the HTTP request to the IP address of the mobile phone web server 12 as is well known in the art. The HTTP request is then routed to the packet-switched RAN 18 based on the IP address. The GGSN 28 inspects the URI/URL, identifies the mobile phone web server 12 based on the IP address, and forwards the HTTP request to the mobile phone 10 via the SGSN 26 and BSS 24.

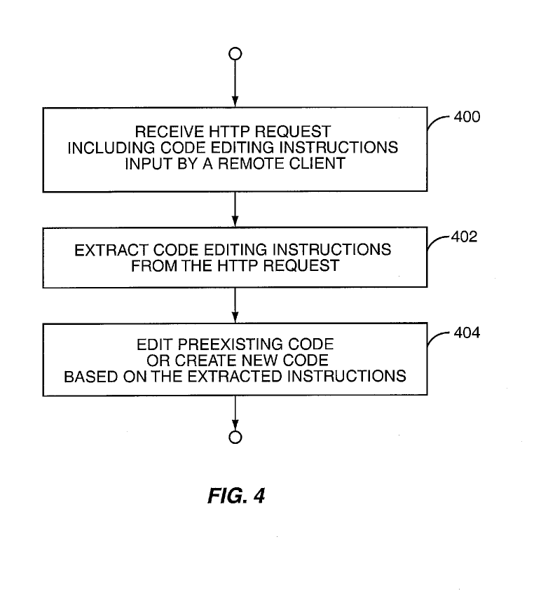

The mobile phone web server 12 receives the HTTP request from the BSS 24, e.g., as illustrated by Step 400 of FIG. 4. The web server 12 recognizes that the HTTP request is dynamic based on the URL/URI included in the request. That is, the web server 12 recognizes that the HTTP request is not simply requesting staticweb page content. Instead, the web server 12 recognizes that the HTTP request identifies the mobile phone code editor 14. In FIG. 2, the mobile phone code editor 14 corresponds to a script-based program named ‘editor.cgi.’ The web server 12 recognizes that the HTTP request is dynamic in this example because the conventional default CGI directory ‘cgi-bin’ is identified in the URL/URI. Broadly, the web server 12 may recognize a dynamic HTTP request based on the URL/URI address included in the request or any other mechanism included in the request.

The web server 12 or code editor 14 extracts the code editing instructions included in the HTTP request in response to recognizing that the request is dynamic, e.g., as illustrated by Step 402 of FIG. 4. The extracted instructions are stored in the mobile phone memory 16 for use by the code editor 14. The code editor 14 then creates new code or edits code stored at the mobile phone 10 based on the extracted instructions, e.g., as illustrated by Step 404 of FIG. 4. For example, based on FIG. 2, the code editor 14 executes the ‘editor.cgi’ script stored at the mobile phone 10 based on code extracted from the HTTP request. Broadly, the HTTP request may identify any type of code editing program supported by the mobile phone 10 such as a script-based program like Server Side Includes (SSI), PHP, Active Server Pages (ASP), PERL, Python, Ruby, Smalltalk, Lisp, Boo, etc. or even a compiler program such as a C/C++ or Java compiler. The mobile phone code editor 14 may optionally embed the code editing results (e.g., modified source code or parsed script code) in a web page for viewing by the remote web browser user. The web page is then packaged as an HTTP response generated by the web server 12 and sent to the remote computer 20 over a network layer connection established with the computer 20. The remote web browser 30 displays the code editing results as a web page.

The mobile phone code editor 14 may optionally implement AJAX (Asynchronous JavaScript and XML) or other similar techniques for embedding code (e.g., compiled source code or script code) in a web page. The mobile phone web server 12 generates an HTTP response including the embedded code and sends the HTTP response to the remote computer 20 over a network layer connection established with the computer 20. A code processor 31 included in or associated with the remote web browser 30 generates parts of the HTML code defining the web page. The browser code processor 31 may, based on the instructions in the embedded code, modify content of the web page in response to user input. The embedded code running on the browser code processor 31 may communicate with the mobile phone code editor 14 by sending an XMLHttpRequest message. The browser code processor 31 may, based on the instructions in the embedded code, modify content of the web page responsive to a message generated by the mobile phone web server 12 and code editor 14 after an XMLHttpRequest was received by the web server 12.

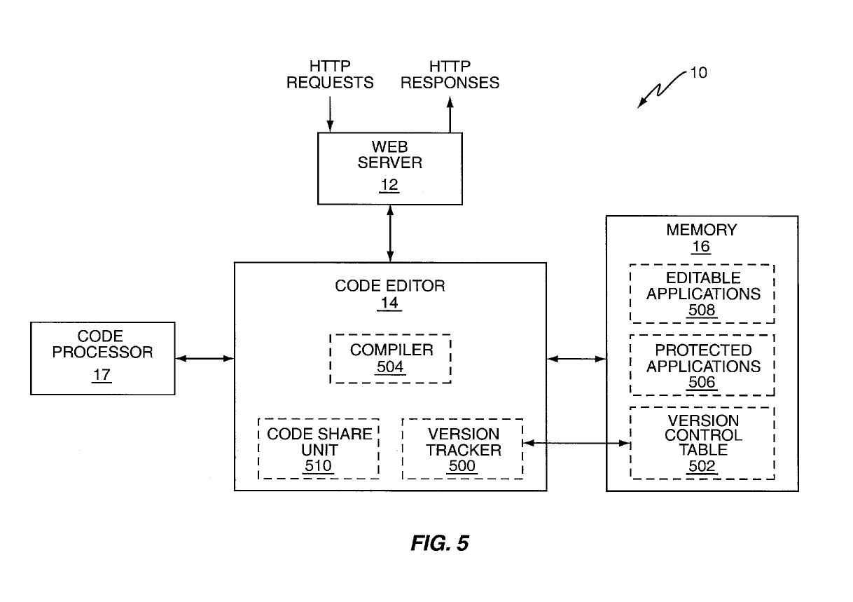

FIG. 5 illustrates an embodiment of the mobile phone 10. According to this embodiment, the web server 12 receives HTTP requests and sends HTTP responses as previously described. The web server 12 may be based on any conventional web server program such as the Apache HTTP server, the Internet Information Services (IIS) server, the Sun Java system server, the Zeus server, or the like. The code editor 14 executes code editing instructions extracted from received HTTP requests also as previously described.

A code version tracker 500 is included in or associated with the code editor 14. The code version tracker 500 maintains a table 502, e.g., in the mobile phone memory 16. The table 502 identifies different versions of the same code edited by the code editor 14. This way, a defective version of code may be replaced with a known good version. If the code is subsequently accessed, the defective version is not used. Instead, only a valid version of the code is used. In some embodiments, the code version tracker 500 is a revision control system such as CVS, SubVersion or ClearCase which stores the code belonging to different code revisions in the file storage 13. A code compiler 504 may also be included in or associated with the code editor 14. The compiler 504 is provided for translating or compiling edited or newly created source code, e.g., into a code format that may be executed by the code processor 17. In other embodiments, the compiler 504 may be omitted if the code only requires interpretation and not compilation. According to these embodiments, the code is directly executed by the code processor 17 which functions as a code interpreter.

The code editor 14 may be prevented from accessing code associated with protected applications 506 such as a radio access protocol stack, TCP-IP protocol stack, media codecs, graphics libraries, mobile phone file system, etc. In one embodiment, a designated folder (not shown) is provided for storing code associated with editable applications 508 such as a menu system, phone book, Short Message Service (SMS) editor, Multimedia Messaging Service (MMS) editor, Wireless Access Protocol (WAP) browser, calendar, media player, email reader, RSS reader, etc. The code editor 14 does not have access to code stored in other folders. In another embodiment, code associated with the protected applications 506 is stored in a restricted folder. In yet another embodiment, the code editing capability of the mobile phone 10 is disabled by default. Accordingly, the mobile phone user must enable the code editor 14 before using this feature. In one embodiment, a password is required to enable the code editor 14.

A code share unit 510 included in or associated with the code editor 14 enables the mobile phone 10 to share edited and/or newly created code with other devices. The code share unit 510 may automatically send code stored in a predetermined folder such as a public folder to a remote code repository 34 addressable via the PSDN 22. In another embodiment, the mobile phone user manually selects which code is shared. Regardless, the code share unit 510 enables code sharing between the mobile phone 10 and the remote code repository 34. The code share unit 510 may also enable the mobile phone 10 to receive code from the remote code repository 34.

With the above range of variations and applications in mind, it should be understood that the present invention is not limited by the foregoing description, nor is it limited by the accompanying drawings. Instead, the present invention is limited only by the following claims, and their legal equivalents.

What is claimed is:

1. In a mobile phone, a method of processing code comprising:
receiving a hypertext transfer protocol (HTTP) request generated by a remote HTTP client, the HTTP request including one or more code editing instructions; and
editing code stored at the mobile phone or creating new code based on the one or more code editing instructions included in the HTTP request using a program identified by the HTTP request.

2. The method of claim 1, wherein editing code stored at the mobile phone comprises adding code to a file stored at the mobile phone.

3. The method of claim 1, wherein editing code stored at the mobile phone comprises deleting code from a file stored at the mobile phone.

4. The method of claim 1, wherein editing code stored at the mobile phone comprises replacing code in a file stored at the mobile phone.

5. The method of claim 1, wherein receiving the HTTP request comprises receiving an HTTP GET request.

6. The method of claim 1, wherein receiving the HTTP request comprises receiving an HTTP POST request.

7. The method of claim 1, wherein receiving the HTTP request comprises receiving an XMLHttpRequest.

8. The method of claim 1, wherein creating new code comprises executing the program identified by the HTTP request based on the one or more code editing instructions included in the HTTP request.

9. The method of claim 1, further comprising sending an HTTP response to the remote HTTP client, the HTTP response including code editing results generated in response to the HTTP request.

10. The method of claim 1, further comprising authenticating the remote HTTP client before processing the HTTP request.

11. The method of claim 1, further comprising deactivating the program identified by the HTTP request unless the program is activated by a user of the mobile phone.

12. The method of claim 1, further comprising tracking different versions of edited or newly created code.

13. The method of claim 1, further comprising registering edited or newly created code with a remote code repository.

14. A mobile phone, comprising:
a web server configured to process a hypertext transfer protocol (HTTP) request generated by a remote HTTP client, the HTTP request including one or more code editing instructions; and
a code editor configured to edit code stored at the mobile phone or create new code based on the one or more code editing instructions included in the HTTP request using a program identified by the HTTP request.

15. The mobile phone of claim 14, wherein the code editor is configured to add code to a file stored at the mobile phone based on the one or more code editing instructions included in the HTTP request.

16. The mobile phone of claim 14, wherein the code editor is configured to delete code from a file stored at the mobile phone based on the one or more code editing instructions included in the HTTP request.

17. The mobile phone of claim 14, wherein the code editor is configured to replace code in a file stored at the mobile phone based on the one or more code editing instructions included in the HTTP request.

18. The mobile phone of claim 14, wherein the web server is configured to receive at least one of an HTTP GET request including the one or more code editing instructions, an HTTP POST request including the one or more code editing instructions, and an XMLHttpRequest including the one or more code editing instructions.

19. The mobile phone of claim 14, wherein the code editor is configured to execute the program identified by the HTTP request based on the one or more code editing instructions included in the HTTP request to generate new code at the mobile phone.

20. The mobile phone of claim 14, wherein the web server is further configured to send an HTTP response to the remote HTTP client, the HTTP response including code editing results generated in response to the HTTP request.

21. A method of remotely editing or creating mobile phone code, comprising:
establishing a transport layer internet protocol (IP) connection with a web server included in a mobile phone; and
sending a hypertext transfer protocol (HTTP) request to the web server over the transport layer IP connection, the HTTP request identifying a program stored at the mobile phone configured to edit code stored at the mobile phone or create new code at the mobile phone based on one or more code editing instructions included in the HTTP request.

22. The method of claim 21, further comprising processing an HTTP response received from the web server included in the mobile phone, the HTTP response including code editing results generated in response to the HTTP request.

23. A computer for remotely editing or creating mobile phone code, the computer comprising a web browser configured to generate a hypertext transfer protocol (HTTP) request for delivery to a web server included in a mobile phone over a transport layer internet protocol (IP) connection established with the web server, the HTTP request identifying a program stored at the mobile phone configured to edit code stored at the mobile phone or create new code at the mobile phone based on one or more code editing instructions included in the HTTP request.

24. The computer of claim 23, wherein the web browser is further configured to process an HTTP response received from the web server included in the mobile phone, the HTTP response including code editing results generated in response to the HTTP request.
